(19) United States
(12) Patent Application Publication
(10) Pub. No.: US 2023/0129704 A1
(43) Pub. Date: Apr. 27, 2023

(54) METHOD FOR BUILDING URBAN CANOPY MODEL BASED ON TROPICAL ISLAND CLIMATE CHARACTERISTICS

(71) Applicant: China Academy of Building Research, Beijing (CN)

(72) Inventors: Haizhu Zhou, Beijing (CN); Qingqin Wang, Beijing (CN); Xiaoping Li, Beijing (CN); Hai Wang, Beijing (CN); Yitong Li, Beijing (CN); Yingchun Xu, Beijing (CN); Huifen Lv, Beijing (CN); Daokun Zhong, Beijing (CN); Mingkai Du, Beijing (CN); Yanquan Cui, Beijing (CN)

(73) Assignee: China Academy of Building Research, Beijing (CN)

(21) Appl. No.: 17/873,185

(22) Filed: Jul. 26, 2022

(30) Foreign Application Priority Data
Oct. 22, 2021 (CN) 202111236079.4

(51) Int. Cl. G01W 1/10

(52) U.S. Cl. CPC G01W 1/10

(57) ABSTRACT

Provided is a method for building an urban canopy model based on tropical island climate characteristics. Adjacent regions are linked together, multiple streets of finite lengths within the regions affecting each other. Net radiation heat flux Q*=long-wave radiation+short-wave radiation. The tropical island urban canopy model considers the strong solar radiation and high temperature and high humidity climate characteristics of tropical cities and the influence of perennial monsoons on island cities, improves the methods of processing long-wave radiation flux, short-wave radiation flux, sensible and latent heat flux, street canyon wind velocity, heat storage flux, anthropogenic heat flux and horizontal heat flux on the basis of an urban canopy model, and has higher adaptability to the studies on the tropical island-type urban heat island effect.

### CROSS-REFERENCE TO RELATED APPLICATION

This application claims the priority benefit of China application no. 202111236079.4, filed on Oct. 22, 2021. The entirety of the above-mentioned patent application is hereby incorporated by reference and made a part of this specification.

### FIELD OF THE INVENTION

The present invention relates to the field of urban canopies, in particular to a method for building an urban canopy model based on tropical island climate characteristics.

### BACKGROUND OF THE INVENTION

In current research on the urban heat island effect, the classic urban canopy model is generally used to model urban street canyons. However, due to the huge differences in longitude and latitude, local climate characteristics, landform and land use characteristics of cities, the parameterization methods in the urban canopy model are very different. The impact of horizontal ventilation characteristics in the urban canopy model on the heat island effect is substantially processed by “ignoring for small impact”, and is insignificant to study the heat island effect of “tropical island” cities, because tropical islands have strong horizontal ventilation characteristics brought about by perennial strong winds.

### SUMMARY OF THE INVENTION

In view of the above problems, the present invention provides a method for building an urban canopy model based on tropical island climate characteristics to overcome the above problems or at least partially solve the above problems.

According to an aspect of the present invention, a method for building an urban canopy model based on tropical island climate characteristics is provided, the building method including:

linking adjacent regions together, multiple streets of finite lengths within the regions affecting each other;

the energy balance equation in a street is as follows:

Q*ₛ+Q_{F,s}=Q_{H,s}+Q_{E,s}+ΔQ_{S,s}+ΔQ_{A,s}

where Q* is a net radiation heat flux, in unit of W/m²; Q_{F} is anthropogenic heat production, in unit of W/m²; Q_{H} is a sensible heat flux, in unit of W/m²; Q_{E} is a latent heat flux, in unit of W/m²; ΔQ_{S} is a net heat storage flux, in unit of W/m²; ΔQ_{A} is a net convective heat flux, in unit of W/m²; s is the street;

net radiation heat flux Q*=long wave radiation+short-wave radiation.

Optionally, the long wave radiation includes:

net long wave radiation of a pavement Lᵣ* is:

Lᵣ*=ϵᵣΨᵣL^{↓}−ϵᵣσTᵣ⁴+ϵᵣϵ_{w}(1−Ψᵣ)σT_{w}⁴+ϵᵣ(1−ϵ_{w})(1−Ψᵣ)Ψ_{w}L^{↓}+ϵᵣϵ_{w}(1−ϵ_{w})(1−‥ᵣ)(1−2Ψ_{w})σT_{w}⁴+ϵᵣ(1−ϵ_{w}(1−Ψᵣ)Ψ_{w}σϵᵣTᵣ⁴

and net long wave radiation of a wall L_{w}* is:

L_{w}*=ϵ_{w}Ψ_{w}L^{↓}−ϵ_{w}σT_{w}⁴+ϵ_{w}Ψ_{w}σϵᵣTᵣ⁴+ϵ_{w}²(1−2Ψ_{w})σT_{w}⁴+ϵ_{w}(1−ϵᵣ)ΨᵣΨ_{w}L^{↓}+ϵ_{w}(1−ϵ_{w})Ψ_{w}(1−2Ψ_{w})L^{↓}+ϵ_{w}²(1−ϵ_{w})(1−2Ψ_{w})²σT_{w}⁴+ϵ_{w}²(1−ϵᵣ)Ψ_{w}(1−Ψᵣ)σT_{w}⁴+ϵ_{w}(1−ϵ_{w})Ψ_{w}(1−2Ψ_{w})σϵᵣTᵣ⁴

where L↓ is the amount of solar radiation, σ is a standard deviation, Tᵣ and T_{w} are temperatures of the pavement and the wall, and ϵᵣ and ϵ_{w} are emissivities of the pavement and the wall; for the pavement, if Ψᵣ is a sky viewing angle coefficient of the pavement to the sky, (1−Ψᵣ) is a sky viewing angle coefficient of the pavement to the walls on both sides; a sky viewing angle coefficient of the wall to the sky is Ψ_{w}, a sky viewing angle coefficient to the pavement is Ψ_{w}, then a sky viewing angle coefficient to the opposite wall is (1−2Ψ_{w}), and the sky viewing angle coefficient is 1.0 for a roof;

the sky viewing angle coefficient is calculated using a plane angle, the sky viewing angle coefficient at the w/2 position of the pavement is

$${Ψ}_{r} ( y = w / 2 ) = 1 + \frac{1}{π} {tan}^{- 1} ( \frac{h / w}{{( h / w )}^{2} - 1 / 4} ) for h / w \leq 1 / 2$$

$${Ψ}_{r} ( y = w / 2 ) = 1 - \frac{1}{π} {tan}^{- 1} ( \frac{h / w}{{( h / w )}^{2} - 1 / 4} ) for h / w \geq 1 / 2$$

the sky viewing angle coefficient at the intersection of the wall and the pavement is

$${Ψ}_{w} ( z = 0 ) = \frac{1}{π} {tan}^{- 1} ( \frac{1}{h / w} ) ,$$

where h represents the height of a street canyon, and w represents the width of the street canyon.

Optionally, the short-wave radiation includes:

average direct solar radiant fluxes of the pavement [symbol] , west wall [symbol] , east wall [symbol] and roof [symbol] are calculated according to the perpendicular angle of the street to the sun direction:

$${S}_{r}^{⇓} ( θ = \frac{π}{2} ) = \{ \begin{matrix}0 & for \vert λ \vert > {λ}_{0} \\ [ 1 - \frac{h}{w} tan ( λ ) ] {S}^{⇓} & for \vert λ \vert < {λ}_{0}\end{matrix}$$

$${S}_{w w}^{⇓} ( θ = \frac{π}{2} ) = \{ \begin{matrix}\frac{1}{2} \frac{w}{h} {S}^{⇓} & for - \frac{π}{2} \leq λ \leq - {λ}_{0} \\ \frac{1}{2} tan ( λ ) {S}^{⇓} & for - {λ}_{0} \leq λ \leq 0 \\ 0 & for 0 \leq λ \leq \frac{π}{2}\end{matrix}$$

$${S}_{w e}^{⇓} ( θ = \frac{π}{2} ) = \{ \begin{matrix}0 & for - \frac{π}{2} \leq λ \leq - {λ}_{0} \\ \frac{1}{2} tan ( λ ) {S}^{⇓} & for - {λ}_{0} \leq λ \leq 0 \\ \frac{1}{2} \frac{w}{h} {S}^{⇓} & for 0 \leq λ \leq \frac{π}{2}\end{matrix}$$

$${S}_{R}^{⇓} ( θ = \frac{π}{2} ) = χ {S}^{⇓}$$

where [symbol] is direct solar radiation on a horizontal surface, θ is an angle between a sun angle and an axial direction of the street canyon, λ is an angle between a sun direction and a normal direction of the wall, χ is a ratio of a direct radiation to a total radiation at a top of the street canyon, h is a height of the street canyon, and w is a width of the street canyon;

according to the orientation change of the street canyon, the width w of the street canyon is corrected as w/sin θ; after a heat flux of the wall is obtained, the heat flux of the wall is multiplied by sine) for correction, where θ₀ is an orientation of the street canyon where the pavement does not receive direct sunlight at all

$${θ}_{0} = arcsin ( min ( \frac{w}{h} \frac{1}{tan λ} ; 1 ) )$$

all direct radiant fluxes obtained by the street canyon are averaged according to all possible changes in the direction of the street canyon, wherein two integrals are used, one between θ=0 and θ=θ₀, and the other between θ=θ₀ and

$$θ = \frac{π}{2} ;$$

wherein average direct solar fluxes of the wall, the pavement and the roof are:

$${S}_{r}^{⇓} = {S}^{⇓} [ \frac{2 {θ}_{0}}{π} - \frac{2}{π} \frac{h}{w} tan ( λ ) ( 1 - cos ( {θ}_{0} ) ) ]$$

$${S}_{w}^{⇓} = {S}^{⇓} [ \frac{w}{h} ( \frac{1}{2} - \frac{{θ}_{0}}{π} ) + \frac{1}{π} tan ( λ ) ( 1 - cos ( {θ}_{0} ) ) ]$$

$${S}_{R}^{⇓} = {S}^{⇓}$$

S^{↓} is a scattered solar radiation available on the horizontal surface, and an amount of scattered solar radiation received by a surface in the street canyon is directly obtained from the sky viewing angle coefficient; due to an influence of a shape of the street canyon and high-reflectivity building surface materials, the short-wave radiation is calculated to solve a geometric system with an infinite number of reflecting surfaces, a reflecting processes of which are assumed to be isentropic processes;

when direct and diffuse reflectivities of each surface are the same, an energy stored by the pavement Aᵣ and an energy stored by the wall A_{w} when a first reflection occurs are:

Aᵣ(0)=(1−αᵣ)( [symbol] +Sᵣ^{↓})

A_{w}(0)=(1−α_{w})( [symbol] +S_{w}^{↓})

where αᵣ and α_{w} represent the reflectivities of the pavement and the wall, respectively;

the energies of the reflected parts from the pavement R, and from the wall R_{w} are:

Rᵣ(0)=αᵣ( [symbol] +Sᵣ^{↓})

R_{w}(0)=α_{w}( [symbol] +S_{w}^{↓})

after n reflections occur,

Aᵣ(n+1)=Aᵣ(n)+(1−αᵣ)(1−Ψᵣ)R_{w}(n)

A_{w}(n+1)=A_{w}(n)+(1−αᵣ)Ψ_{w}Rᵣ(n)+(1−α_{w})(1−2Ψ_{w})R_{w}(n)

Rᵣ(n+1)=αᵣ(1−Ψᵣ)R_{w}(n)

R_{w}(n+1)=α_{w}Ψ_{w}Rᵣ(n)+α_{w}(1−2Ψ_{w})R_{w}(n)

the following is obtained according to recursive formulas,

$${A}_{r} ( n + 1 ) = {A}_{r} ( 0 ) + ( 1 - {α}_{r} ) ( 1 - {Ψ}_{r} ) {\sum }_{k = 0}^{n} {R}_{w} ( k )$$

$${A}_{w} ( n + 1 ) = {A}_{w} ( 0 ) + {Ψ}_{w} ( 1 - {α}_{r} ) {\sum }_{k = 0}^{n} {R}_{w} ( k ) + ( 1 - 2 {Ψ}_{w} ) ( 1 - {α}_{w} ) {\sum }_{k = 0}^{n} {R}_{w} ( k )$$

$$and$$

$${\sum }_{k = 0}^{n} {R}_{r} ( k ) = ( 1 - {Ψ}_{r} ) {α}_{r} {\sum }_{k = 0}^{n - 1} {R}_{w} ( k ) + {R}_{r} ( 0 )$$

$${\sum }_{k = 0}^{n} {R}_{w} ( k ) = {α}_{w} {Ψ}_{w} {\sum }_{k = 0}^{n - 1} {R}_{r} ( k ) + {α}_{w} ( 1 - 2 {Ψ}_{w} ) {\sum }_{k = 0}^{n - 1} {R}_{w} ( k ) + {R}_{w} ( 0 )$$

for the infinite reflections, the following is obtained by solving a geometric system,

$${\sum }_{k = 0}^{∞} {R}_{r} ( k ) = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}} \\ {\sum }_{k = 0}^{∞} {R}_{r} ( k ) = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}}$$

Mᵣ is assumed to be a sum of a pavement reflection and M_{w} is assumed to be a sum of wall reflection,

$${M}_{r} = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}} \\ {M}_{w} = \frac{{R}_{w} ( 0 ) + {Ψ}_{w} {α}_{w} {R}_{r} ( 0 )}{1 - ( 1 - 2 {Ψ}_{w} ) {α}_{w} + ( 1 - {Ψ}_{r} ) {Ψ}_{w} {α}_{r} {α}_{w}}$$

where

Rᵣ(0)=αᵣ [symbol] +αᵣSᵣ^{↓}

R_{w}(0)=αᵣ [symbol] +αᵣS_{w}^{↓}

A total solar radiation absorbed by the pavement is Sᵣ*, a total solar radiation absorbed by the wall is S_{w}*, a total solar radiation absorbed by the roof is S_{R}*:

Sᵣ*=(1−αᵣ) [symbol] +(1−αᵣ)Sᵣ^{↓}+(1−αᵣ)(1−Ψᵣ)M_{w}

S_{w}*=(1−α_{w}) [symbol] +(1−α_{w})S_{w}^{↓}+(1−α_{w})(1−2Ψ_{w})M_{w}+(1−α_{w})Ψ_{w}Mᵣ

S_{R}*=(1−α_{R}) [symbol] +(1−α_{R})S_{R}^{↓}.

Optionally, the anthropogenic heat production specifically includes:

A current anthropogenic heat flux in the street canyon is Q_{F}=Q_{FV}+Q_{FH}+Q_{FM};

where Q_{FV}, Q_{FH} and Q_{FM} are heat generated by vehicles, fixed heat sources and biological metabolism, respectively.

Optionally, the sensible heat flux Q_{H} includes:

Q_{H,r,ww,we}=ρCₚC_{H1}U_{can}(T_{r,ww,we}−T_{can})

Q_{H,R}=ρCₚC_{H2}Uₜₒₚ(T_{R}−Tₐᵢᵣ)

Q_{H,can}=ρCₚC_{H2}Uₐᵢᵣ(T_{can}−Tₐᵢᵣ)

where r, ww, we, R, and can refer to the pavement, the west wall, the east wall, the roof, and the street canyon, respectively; ρ is an air density; Cₚ is a specific heat under constant pressure; T_{can} is a temperature in a center of the street canyon (w/2, h/2); U_{can} and Uₜₒₚ are a wind velocity in the center of the street canyon (w/2, h/2) and a wind velocity above the street canyon;

Uₐᵢᵣ and Tₐᵢᵣ are an input wind velocity and an input temperature at a reference height of a turbulence model, and C_{H1} and C_{H2} are dimensionless velocity transfer coefficients; differences between the C_{H1} and C_{H2} are only a height and a roughness of a reference layer; the same zero plane layer and roughness are used, and the values of the two are equal, and are calculated as follows:

$${C}_{H *} {u}_{*} = \frac{{ku}_{*}}{{Ψ}_{h}}$$

where k is a Von Karman constant, u_{*} is a friction velocity of the reference layer, and Ψₕ is a general integral function,

$${Ψ}_{h} = {\int }_{{ζ}^{T}}^{{ζ}^{′}} \frac{{ϕ}_{h}}{ζ} d ζ$$

where ζ′=(zₐ−d)/L; ζ^{T}=z_{T}/L, Z_{T} is a roughness length of a heat flow; L is an Obukhov stability length,

$$L = - \frac{ρ {C}_{p} T {u}_{*}^{3}}{{kgH}_{a}}$$

where T is an average temperature of this layer, Hₐ is an air flux between the street canyon and an atmosphere, and L is an implicit function, which is solved by simplified iteration; when a specific heat of air in an urban canopy is ignored, Hₐ is a weighted average of a wall flux and a road flux in the street canyon, that is,

Hₐ=2(h/w)Q_{w}+Q_{R}

in a TEB model proposed by Masson, C_{H*}u_{*} is a reciprocal of aerodynamic resistance, i.e. 1/RES*, which is determined by the wind velocities in the street canyon and at a top of the street canyon;

if a surface covered by plants such as green space is not considered, an average sensible heat flow of the street canyon depends on a weighted average area of the roof, the wall and the pavement,

$${Q}_{H} = \frac{b {Q}_{H , R} + w {Q}_{H , r} + h ( {Q}_{H , ww} + {Q}_{H , we} )}{w + b} ,$$

wherein h is a height of the street canyon, w is a width of the street canyon, and b is an average width of the buildings.

Optionally, the latent heat flux Q_{E} includes:

a direct latent heat flow between a building roof and the atmosphere

Q_{E,R}=lᵥB_{R}ρC_{H2}Uₜₒₚ(q_{R}−qₐᵢᵣ)

where lᵥ is a latent heat of evaporation, B_{R} is a humidity parameter of the roof, between 0 and 1, 0 is completely dry, 1 is completely wet, a value of B depends on the plant and a water conditions of the surface, ρ is a density of the air, C_{H2} is a dimensionless velocity transfer coefficient, and q_{R} is a humidity of the roof; qₐᵢᵣ is a humidity at the reference height,

a latent heat flow is calculated using a similarity law for the air on the pavement and the wall and in the street canyon

Q_{E,r}=lᵥBᵣρC_{H1}U_{ca}n(qᵣ−q_{can})

Q_{E,w}=0

wherein CH2 is a dimensionless velocity transfer coefficient, and qᵣ is a humidity of the pavement; q_{can} is a humidity at the street canyon,

a latent heat flow between an interior of the street canyon and a top atmosphere is

Q_{E,can}=lᵥρC_{H2}Uₐᵢᵣ(q_{can}−qₐᵢᵣ).

Optionally, the net heat storage flux ΔQ_{S} includes:

because there is a temperature gradient inside the building or the pavement, the roof, the wall and the pavement are assumed to be of at least three-layer structures; for an outermost layer structure, heat transfer equations of the three planes are written as,

$${C}_{R 1} \frac{\partial {T}_{R 1}}{\partial t} = \frac{{λ}_{R 1}}{{d}_{R 1}} ( {S}_{R}^{*} + {L}_{R}^{*} - {H}_{R} - L {E}_{R} - {G}_{R 1 - 2} ) \\ {C}_{w 1} \frac{\partial {T}_{w 1}}{\partial t} = \frac{{λ}_{w 1}}{{d}_{w 1}} ( {S}_{w}^{*} + {L}_{w}^{*} - {H}_{w} - {G}_{w 1 - 2} ) \\ {C}_{r 1} \frac{\partial {T}_{r 1}}{\partial t} = \frac{{λ}_{r 1}}{{d}_{r 1}} ( {S}_{r}^{*} + {L}_{r}^{*} - {H}_{r} - L {E}_{r} - {G}_{r 1 - 2} )$$

where T_{*i} is a temperature of the i-th layer; C_{*i} is a specific heat capacity of the air; d_{*i} is a layer thickness, fluxes S_{*}*, L_{*}*, H_{*}, LE_{*}, and G_{*1-2} are net solar radiation, net infrared radiation, sensible heat, latent heat, and thermal conductivity between the surface layer and the next layer, and the thermal conductivity is calculated using a Fourier heat conduction equation,

$${G}_{* 1 - 2} = \frac{{λ}_{* 1 - 2}}{0.5 ( {d}_{* 1} + {d}_{* 2} )} ( {T}_{* 1} - {T}_{* 2} )$$

an average thermal conductivity between two adjacent layers λ_{*1-2} is calculated using a geometric average method:

$${λ}_{* 1 - 2} = \frac{{d}_{* 1} + {d}_{* 2}}{( {d}_{* 1} / {λ}_{* 1} ) + ( {d}_{* 2} / {λ}_{* 2} )}$$

where λ_{*i} is a thermal conductivity of the i-th layer;

an inner first layer of the surface is assumed to be a very thin surface, and a temperature of the first layer is simplified to an outer surface temperature; for other inner i-th layers, a thermal conductivity between adjacent layers is calculated; for an innermost layer, such as the n-th layer, an internal temperature of the building is used for the roof and the wall surface, and the 0 flux is used for the pavement;

$${G}_{R n - n + 1} = \frac{{λ}_{R n}}{0.5 {d}_{R n}} ( {T}_{R n} - {T}_{i n} ) \\ {G}_{w n - n + 1} = \frac{{λ}_{w n}}{0.5 {d}_{w n}} ( {T}_{w n} - {T}_{i n} ) \\ {G}_{r n - n + 1} = 0$$

the internal temperature of the building Tᵢₙ and the temperature of the external street canyon are assumed in a quasi-steady equilibrium state, then, if it is assumed that the internal temperature Tᵢₙ of the building under air conditioning or natural ventilation is substantially constant in a tropical island climate, an average temperature in a center of the interior of the building Tᵢₙ is

$${T}_{i n} = \frac{{( h / b )}^{2} ( {T}_{w w} + {T}_{w w} ) + {T}_{R}}{2 {( h / b )}^{2} + 1}$$

where b is an average width of the building.

Optionally, the wind velocity includes:

in the street canyon, the wind velocity is decomposed into a vertical velocity W_{can} along the wall and a horizontal velocity U_{can} along the length of the street; the horizontal velocity along the width of the street is ignored;

according to an observation, in a part close to the top of the street canyon, regardless of an air stability and a wind direction above the street canyon, a standard deviation σ_{w} of a vertical wind velocity is equal to a friction velocity u_{*};

the part σ_{w}/u_{*} close to the roof is 1.15, which is the same order of magnitude as an observed result; for an inertial boundary layer, a deviation of u_{*} is not more than 10%; therefore, for any aspect ratio of the street canyon, the vertical velocity is assumed to be

W_{can}=u_{*}=\sqrt{C_{d}}┌Uₐᵢᵣ┐

where Uₐᵢᵣ is a wind velocity of the first layer of an atmospheric model, and C_{d} is a drag coefficient, which is calculated from the temperature/humidity in and above the street canyon, a roughness Z₀, and a stability effect;

the horizontal wind velocity at the top of the street canyon U_{can} is obtained by means of a Log approximate curve, a processing range of the Log curve being from h/3 of a lower part of the roof to a height of the first layer of the atmospheric model, wherein h is the height of the street canyon; when all street canyon orientations are considered, 360° integral processing is performed, then the velocity at the top of the street canyon Uₜₒₚ is

$${U}_{top} = \frac{2}{π} \frac{ln ( \frac{h / 3}{{z}_{0}} )}{ln ( \frac{Δ z + h / 3}{{z}_{0}} )} ⌈ {U}_{a i r} ⌉$$

where Δz is a height from the roof to the first layer of the atmospheric model;

the horizontal wind velocity U_{can} is determined according to the wind velocity at ½ height of the street canyon;

in order to calculate U_{can}, a reasonable change law of U_{can} in the vertical direction needs to be assumed;

according to a continuity assumption of the wind velocity, a change curve of U_{can} in the vertical direction has the following form

U_{can}=Uₜₒₚ exp(−N/2)

where a value of N is slightly different;

according to an aspect ratio of the street canyon (h/w=1-4), the value of U_{can} varies from 0.75 Uₜₒₚ to 0.4 Uₜₒₚ;

N=0.5(h/w), the horizontal wind velocity in the street canyon U_{can} is

$${U}_{c a n} = \frac{2}{π} exp ( - 0.25 \frac{h}{w} ) \frac{ln ( \frac{h / 3}{{z}_{0}} )}{ln ( \frac{Δ z + h / 3}{{z}_{0}} )} ⌈ {U}_{a i r} ⌉$$

calculations of aerodynamic roughness of the pavement and the wall in the street canyon are simplified, and the two are considered to have equal aerodynamic roughness, which is unrelated to the stability inside and outside the street canyon,

RES_{w}=RESᵣ=(11.8+4.2\sqrt{U_{can}²+W_{can}²})⁻¹

where the parameters RES_{w} and RESᵣ are inverses of CₚC_{H1} and CₚC_{H2}, and are used for calculating sensible and latent heat flows.

Optionally, the net convective heat flux is:

under quasi-steady state conditions, the wind flow in an x-axis direction has been stable along the length of the street canyon; if an influence of pedestrians and vehicles inside the street is not considered, laws of mass conservation and momentum conservation are used in the x-axis direction, so as to obtain the horizontal movement of air inside the street canyon;

if the air density and the horizontal velocity in the street canyon are processed as quasi-steady state variables, then in the case where an entrance velocity and an exit velocity satisfy outflow conditions, the laws of mass conservation and momentum conservation are written as follows according to a one-dimensional flow equation in the x-axis direction:

$$\{ \begin{matrix}\frac{\partial ( ρ \overline{u} )}{\partial x} = {\dot{m}}_{c} \\ \frac{\partial ( ρ {\overline{u}}^{2} )}{\partial x} + \frac{\partial p}{\partial x} + \frac{\partial {τ}_{w}}{\partial x} = 0 \\ {\overline{u} \vert}_{x = {x}_{0}} = {\overline{u}}_{i n} \\ {\overline{u} \vert}_{x = {x}_{0} + L} = {\overline{u}}_{out} \\ {\frac{d \overline{u}}{dx} \vert}_{x = {x}_{0} + L} = 0\end{matrix}$$

where ρ is the air density; ū is an average velocity in the x-axis direction; \dot{m}_{c} is a specific volumetric mass flow of air entering or exiting a control body, the specific volume being a ratio of the mass flow of the air entering or exiting the control body to the volume of the control body; p is an average pressure of a cross section of the street canyon; τ_{w} is an average frictional stress of the wall surface and the street surface to the air flow; ūᵢₙ and ūₒᵤₜ are average air velocities at the entrance and exit of the street canyon, respectively; x₀ is an entrance position of the street canyon, and the flow velocity at the entrance of the street canyon is measured by an instrument;

from a perspective of regional scale, streets are usually connected to form a street network; by studying a road network, a horizontal flux of the urban heat island phenomenon can be replaced by a street canyon formed by only one independent street; when the horizontal flux of a crossroad is calculated, a Kirchhoff's principle for calculating a fluid network can be used; according to a topological structure and plan theory of the street network, a street network can be represented by a corresponding adjacency matrix, and the horizontal air flow of each branch can be solved;

for a scenario at a crossroad, it is assumed that the horizontal flux at the exit of street m is Q_{m,out} and the horizontal flux at the exit of street j is Q_{j,out}, the horizontal flux at the entrance of street I is Q_{i,out} and the horizontal flux at the entrance of street n is Q_{n,out}; then, according to the law of energy conservation, a horizontal flux at a node is:

(ρ\dot{V}ₘQ_{m,out})+(ρ\dot{V}ⱼQ_{j,out})=ρQₘᵢₙ(\dot{V}ₙ+\dot{V}ᵢ)

where \dot{V} is an air volume flow of each street canyon; Qₘᵢₓ is a mixed horizontal flux;

the mixed horizontal flux Qₘᵢₓ is the horizontal flux flowing into the entrances of street canyons n and i at the node,

$${Q}_{mix} = \frac{ρ {\sum }_{All outflowing branch} {( \dot{V} )}^{k}}{{\sum }_{All inflowing branch} {( ρ \dot{V} {Q}_{out} )}^{k}} .$$

The tropical island urban canopy model provided by the present invention considers the strong solar radiation and high temperature and high humidity climate characteristics of tropical cities and the influence of perennial monsoons on island cities, improves the methods of processing long-wave radiation flux, short-wave radiation flux, sensible and latent heat flux, street canyon wind velocity, heat storage flux, anthropogenic heat flux and horizontal heat flux on the basis of an urban canopy model, and has higher adaptability to the studies on the tropical island-type urban heat island effect.

The above description is only a summary of the technical solutions of the present invention. In order to be able to understand the technical means of the present invention more clearly, it can be implemented according to the content of the description, and in order to make the above and other objectives, features and advantages of the present invention more obvious and easier to understand, the following specific embodiments of the present invention are given.

### BRIEF DESCRIPTION OF THE DRAWINGS

In order to illustrate the technical solutions of the embodiments of the present invention more clearly, the following briefly introduces the accompanying drawings used in the description of the embodiments. Apparently, the drawings in the following description are merely some embodiments of the present invention. For those of ordinary skill in the art, other drawings can also be obtained from these drawings without any creative effort.

FIG. 1 is a cross-sectional view of a street canyon canopy model according to an embodiment of the present invention.

FIG. 2 is an air flow analysis diagram along the length of a street according to an embodiment of the present invention.

FIG. 3 shows horizontal flux of a street canyon network at a node according to an embodiment of the present invention.

### DETAILED DESCRIPTION OF THE EMBODIMENTS

Exemplary embodiments of the present disclosure will be described in more detail below with reference to the accompanying drawings. Although the drawings show the exemplary embodiments of the present disclosure, it should be understood that the present disclosure may be implemented in various forms and should not be limited to the embodiments illustrated herein. On the contrary, these embodiments are provided so that the present disclosure can be understood more thoroughly, and can fully convey the scope of the present disclosure to those skilled in the art.

The terms “include” and “have” and any variations thereof in the description embodiments, claims and drawings of the present invention are intended to cover non-exclusive inclusion, for example, including a series of steps or elements.

The technical solution of the present invention will be described in further detail below with reference to the accompanying drawings and embodiments.

Main assumptions of a tropical island urban canopy model are as follows:

The space formed by a road and opposite sides of buildings on both sides is referred to as a street canyon.

The length of the road is much greater than its width. The aspect ratio of a street changes with the actual situation of the road.

The angle between the direction of the road and the sun exposure is arbitrary.

The buildings on both sides of the road have the same height and width, and the roof height is the surface layer height of an atmospheric model.

The air flow and energy exchange in the street canyon change slowly, with hourly time resolution. The thermal and dynamic processes of the heat island effect can be regarded as quasi-steady state processes.

Feedbacks of urban heat islands on the external atmospheric effect are ignored.

A 2-layer model is used to describe the heat conduction among a pavement, a wall and a roof.

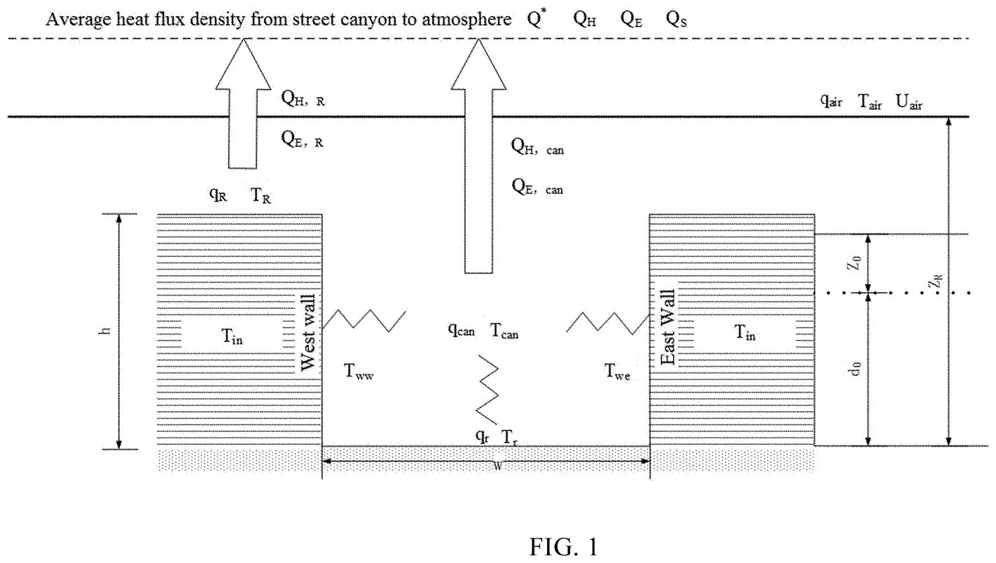

As shown in FIG. 1, a method for building an urban canopy model based on tropical island climate characteristics includes:

linking adjacent regions together, multiple streets of finite lengths within the regions affecting each other;

The energy balance equation in a street is as follows:

Q*ₛ+Q_{F,s}=Q_{H,s}+Q_{E,s}+ΔQ_{S,s}+ΔQ_{A,s}

where Q* is a net radiation heat flux, in unit of W/m²; Q_{F} is anthropogenic heat production, in unit of W/m²; Q_{H} is a sensible heat flux, in unit of W/m²; Q_{E} is a latent heat flux, in unit of W/m²; ΔQ_{S} is a net heat storage flux, in unit of W/m²; ΔQ_{A} is a net convective heat flux, in unit of W/m²; s is the street;

Net radiation heat flux Q*=long-wave radiation+short-wave radiation.

The long-wave radiation includes:

net long-wave radiation of a pavement Lᵣ* is:

Lᵣ*=ϵᵣΨᵣL^{↓}−ϵᵣσTᵣ⁴+ϵᵣϵ_{w}(1−Ψᵣ)σT_{w}⁴+ϵᵣ(1−ϵ_{w})(1−Ψᵣ)Ψ_{w}L^{↓}+ϵᵣϵ_{w}(1−ϵ_{w})(1−‥ᵣ)(1−2Ψ_{w})σT_{w}⁴+ϵᵣ(1−ϵ_{w}(1−Ψᵣ)Ψ_{w}σϵᵣTᵣ⁴

and net long-wave radiation of a wall L_{w}* is:

L_{w}*=ϵ_{w}Ψ_{w}L^{↓}−ϵ_{w}σT_{w}⁴+ϵ_{w}Ψ_{w}σϵᵣTᵣ⁴+ϵ_{w}²(1−2Ψ_{w})σT_{w}⁴+ϵ_{w}(1−ϵᵣ)ΨᵣΨ_{w}L^{↓}+ϵ_{w}(1−ϵ_{w})Ψ_{w}(1−2Ψ_{w})L^{↓}+ϵ_{w}²(1−ϵ_{w})(1−2Ψ_{w})²σT_{w}⁴+ϵ_{w}²(1−ϵᵣ)Ψ_{w}(1−Ψᵣ)σT_{w}⁴+ϵ_{w}(1−ϵ_{w})Ψ_{w}(1−2Ψ_{w})σϵᵣTᵣ⁴

where L↓ is the amount of solar radiation, σ is a standard deviation, Tᵣ and T_{w} are temperatures of the pavement and the wall, and ϵᵣ and ϵ_{w} are emissivities of the pavement and the wall; for the pavement, if Ψᵣ is a sky viewing angle coefficient of the pavement to the sky, (1−Ψᵣ) is a sky viewing angle coefficient of the pavement to the walls on both sides; a sky viewing angle coefficient of the wall to the sky is Ψ_{w}, a sky viewing angle coefficient to the pavement is Ψ_{w}, then a sky viewing angle coefficient to the opposite wall is (1−2Ψ_{w}), and the sky viewing angle coefficient is 1.0 for a roof;

The sky viewing angle coefficient is calculated using a plane angle, the sky viewing angle coefficient at the w/2 position of the pavement is

$${Ψ}_{r} ( y = w / 2 ) = 1 + \frac{1}{π} {tan}^{- 1} ( \frac{h / w}{{( h / w )}^{2} - 1 / 4} ) for h / w \leq 1 / 2 \\ {Ψ}_{r} ( y = w / 2 ) = 1 - \frac{1}{π} {tan}^{- 1} ( \frac{h / w}{{( h / w )}^{2} - 1 / 4} ) for h / w \geq 1 / 2$$

The sky viewing angle coefficient at the intersection of the wall and the pavement is

$${Ψ}_{w} ( z = 0 ) = \frac{1}{π} {tan}^{- 1} ( \frac{1}{h / w} ) ,$$

where h represents the height of a street canyon, and w represents the width of the street canyon.

The short-wave radiation includes:

Average direct solar radiant fluxes of the pavement [symbol] , west wall [symbol] , east wall [symbol] and roof [symbol] are calculated according to the perpendicular angle of the street to the sun direction:

$${S}_{r}^{⇓} ( θ = \frac{π}{2} ) = \{ \begin{matrix}0 for \vert λ \vert > {λ}_{0} \\ [ 1 - \frac{h}{w} tan ( λ ) ] {S}^{⇓} for \vert λ \vert < {λ}_{0}\end{matrix} \\ {S}_{ww}^{⇓} ( θ = \frac{π}{2} ) = \{ \begin{matrix}\frac{1}{2} \frac{w}{h} {S}^{⇓} for - \frac{π}{2} \leq λ \leq - {λ}_{0} \\ \frac{1}{2} tan ( λ ) {S}^{⇓} for - {λ}_{0} \leq λ \leq 0 \\ 0 for 0 \leq λ \leq \frac{π}{2}\end{matrix} \\ {S}_{we}^{⇓} ( θ = \frac{π}{2} ) = \{ \begin{matrix}0 for - \frac{π}{2} \leq λ \leq - {λ}_{0} \\ \frac{1}{2} tan ( λ ) {S}^{⇓} for - {λ}_{0} \leq λ \leq 0 \\ \frac{1}{2} \frac{w}{h} {S}^{⇓} for 0 \leq λ \leq \frac{π}{2}\end{matrix} \\ {S}_{R}^{⇓} ( θ = \frac{π}{2} ) = χ {S}^{⇓}$$

where [symbol] is direct solar radiation on a horizontal surface, θ is an angle between a sun angle and an axial direction of the street canyon, λ is an angle between a sun direction and a normal direction of the wall, χ is a ratio of a direct radiation to a total radiation at a top of the street canyon, h is a height of the street canyon, and w is a width of the street canyon;

According to the orientation change of the street canyon, the width w of the street canyon is corrected as w/sin θ; after a heat flux of the wall is obtained, the heat flux of the wall is multiplied by sin θ for correction, where θ₀ is an orientation of the street canyon where the pavement does not receive direct sunlight at all

$${θ}_{0} = arcsin ( min ( \frac{w}{h} \frac{1}{tan λ} ; 1 ) )$$

All direct radiant fluxes obtained by the street canyon are averaged according to all possible changes in the direction of the street canyon, wherein two integrals are used, one between θ=0 and θ=θ₀, and the other between θ=θ₀ and

$$θ = \frac{π}{2} ;$$

Wherein average direct solar fluxes of the wall, the pavement and the roof are:

$${S}_{r}^{⇓} = {S}^{⇓} [ \frac{2 {θ}_{0}}{π} - \frac{2}{π} \frac{h}{w} tan ( λ ) ( 1 - cos ( {θ}_{0} ) ) ] \\ {S}_{w}^{⇓} = {S}^{⇓} [ \frac{w}{h} ( \frac{1}{2} - \frac{{θ}_{0}}{π} ) + \frac{1}{π} tan ( λ ) ( 1 - cos ( {θ}_{0} ) ) ] \\ {S}_{R}^{⇓} = {S}^{⇓}$$

S^{↓} is a scattered solar radiation available on the horizontal surface, and an amount of scattered solar radiation received by a surface in the street canyon is directly obtained from the sky viewing angle coefficient. Due to an influence of a shape of the street canyon and high-reflectivity building surface materials, the short-wave radiation is calculated to solve a geometric system with an infinite number of reflecting surfaces, a reflecting processes of which are assumed to be isentropic processes;

When direct and diffuse reflectivities of each surface are the same, an energy stored by the pavement Aᵣ and an energy stored by the wall A_{w} when a first reflection occurs are:

Aᵣ(0)=(1−αᵣ)( [symbol] +Sᵣ^{↓})

A_{w}(0)=(1−α_{w})( [symbol] +S_{w}^{↓})

where αᵣ and α_{w} represent the reflectivities of the pavement and the wall, respectively;

The energies of the reflected parts from the pavement Rᵣ and from the wall R_{w} are:

Rᵣ(0)=αᵣ( [symbol] +Sᵣ^{↓})

R_{w}(0)=α_{w}( [symbol] +S_{w}^{↓})

After n reflections occur,

Aᵣ(n+1)=Aᵣ(n)+(1−αᵣ)(1−Ψᵣ)R_{w}(n)

A_{w}(n+1)=A_{w}(n)+(1−αᵣ)Ψ_{w}Rᵣ(n)+(1−α_{w})(1−2Ψ_{w})R_{w}(n)

Rᵣ(n+1)=αᵣ(1−Ψᵣ)R_{w}(n)

R_{w}(n+1)=α_{w}Ψ_{w}Rᵣ(n)+α_{w}(1−2Ψ_{w})R_{w}(n)

The following is obtained according to recursive formulas,

$${A}_{r} ( n + 1 ) = {A}_{r} ( 0 ) + ( 1 - {α}_{r} ) ( 1 - {Ψ}_{r} ) {\sum }_{k = 0}^{n} {R}_{w} ( k )$$

$${A}_{w} ( n + 1 ) = {A}_{w} ( 0 ) + {Ψ}_{w} ( 1 - {α}_{r} ) {\sum }_{k = 0}^{n} {R}_{w} ( k ) + ( 1 - 2 {Ψ}_{w} ) ( 1 - {α}_{w} ) {\sum }_{k = 0}^{n} {R}_{w} ( k )$$

$$and \\ {\sum }_{k = 0}^{n} {R}_{r} ( k ) = ( 1 - {Ψ}_{r} ) {α}_{r} {\sum }_{k = 0}^{n - 1} {R}_{w} ( k ) + {R}_{r} ( 0 ) \\ {\sum }_{k = 0}^{n} {R}_{w} ( k ) = {α}_{w} {Ψ}_{w} {\sum }_{k = 0}^{n - 1} {R}_{r} ( k ) + {α}_{w} ( 1 - 2 {Ψ}_{w} ) {\sum }_{k = 0}^{n - 1} {R}_{w} ( k ) + {R}_{w} ( 0 )$$

For the infinite reflections, the following is obtained by solving a geometric system,

$${\sum }_{k = 0}^{∞} {R}_{r} ( k ) = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}} \\ {\sum }_{k = 0}^{∞} {R}_{r} ( k ) = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}}$$

Mᵣ is assumed to be a sum of a pavement reflection and M_{w} is assumed to be a sum of a wall reflection,

$${M}_{r} = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}} \\ {M}_{w} = \frac{{R}_{w} ( 0 ) + {Ψ}_{w} {α}_{w} {R}_{r} ( 0 )}{1 - ( 1 - 2 {Ψ}_{w} ) {α}_{w} + ( 1 - {Ψ}_{r} ) {Ψ}_{w} {α}_{r} {α}_{w}}$$

where

Rᵣ(0)=αᵣ [symbol] +αᵣSᵣ^{↓}

R_{w}(0)=αᵣ [symbol] +αᵣS_{w}^{↓}

A total solar radiation absorbed by the pavement is Sᵣ*, a total solar radiation absorbed by the wall is S_{w}* , a total solar radiation absorbed by the roof is S_{R}*:

Sᵣ*=(1−αᵣ) [symbol] +(1−αᵣ)Sᵣ^{↓}+(1−αᵣ)(1−Ψᵣ)M_{w}

S_{w}*=(1−α_{w}) [symbol] +(1−α_{w})S_{w}^{↓}+(1−α_{w})(1−2Ψ_{w})M_{w}+(1−α_{w})Ψ_{w}Mᵣ

S_{R}*=(1−α_{R}) [symbol] +(1−α_{R})S_{R}^{↓}.

The anthropogenic heat production specifically includes:

current anthropogenic heat flux in the street canyon is Q_{F}=Q_{FV}+Q_{FH}+Q_{FM};

where Q_{FV}, Q_{FH} and Q_{FM} are heat generated by vehicles, fixed heat sources and biological metabolism, respectively.

The sensible heat flux Q_{H} includes:

Q_{H,r,ww,we}=ρCₚC_{H1}U_{can}(T_{r,ww,we}−T_{can})

Q_{H,R}=ηCₚC_{H2}Uₜₒₚ(T_{R}−Tₐᵢᵣ)

Q_{H,can}=ρCₚC_{H2}Uₐᵢᵣ(T_{can}−Tₐᵢᵣ)

where r, ww, we, R, and can refer to the pavement, the west wall, the east wall, the roof, and the street canyon, respectively; ρ is an air density; Cₚ is a specific heat under a constant pressure; T_{can} is a temperature in a center of the street canyon (w/2, h/2); U_{can} and Uₜₒₚ are a wind velocity in the center of the street canyon (w/2, h/2) and a wind velocity above the street canyon;

Uₐᵢᵣ and Tₐᵢᵣ are an input wind velocity and an input temperature at a reference height of a turbulence model, and C_{H1} and C_{H2} are dimensionless velocity transfer coefficients; differences between the C_{H1} and C_{H2} are only a height and a roughness of a reference layer; the same zero plane layer and roughness are used, and the values of the two are equal, and are calculated as follows:

$${C}_{H *} {u}_{*} = \frac{{ku}_{*}}{{Ψ}_{h}}$$

where k is a Von Karman constant, u_{*} is a friction velocity of the reference layer, and Ψₕ is a general integral function,

$${Ψ}_{h} = {\int }_{{ζ}^{T}}^{{ζ}^{′}} \frac{{ϕ}_{h}}{ζ} d ζ$$

where ζ′=(zₐ−d)/L; ζ^{T}=z_{T}/L, z_{T} is a roughness length of a heat flow; L is an Obukhov stability length,

$$L = - \frac{ρ {C}_{p} {Tu}_{*}^{3}}{{kgH}_{a}}$$

where T is an average temperature of this layer, Hₐ is an air flux between the street canyon and an atmosphere, and L is an implicit function, which is solved by simplified iteration. When a specific heat of air in an urban canopy is ignored, Hₐ is a weighted average of a wall flux and a road flux in the street canyon, that is,

Hₐ=2(h/w)Q_{w}+Q_{R}

In a TEB model proposed by Masson, C_{H*}u_{*} is a reciprocal of aerodynamic resistance, i.e. 1/RES_{*}, which is determined by the wind velocities in the street canyon and at a top of the street canyon;

If a surface covered by plants such as green space is not considered, an average sensible heat flow of the street canyon depends on a weighted average area of the roof, the wall and the pavement,

$${Q}_{H} = \frac{{bQ}_{H , R} + {wQ}_{H , r} + h ( {Q}_{H , ww} + {Q}_{H , we} )}{w + b} ,$$

wherein h is a height of the street canyon, w is a width of the street canyon, and b is an average width of the buildings.

Optionally, the latent heat flux Q_{E} includes:

a direct latent heat flow between a building roof and the atmosphere

Q_{E,R}=lᵥB_{R}ρC_{H2}Uₜₒₚ(q_{R}−qₐᵢᵣ)

where lᵥ is a latent heat of evaporation, B_{R} is a humidity parameter of the roof, between 0 and 1, 0 is completely dry, 1 is completely wet, a value of B depends on the plant and water conditions of the surface, ρ is a density of the air, C_{H2} is a dimensionless velocity transfer coefficient, and q_{R} is a humidity of the roof; qₐᵢᵣ is a humidity at the reference height,

A latent heat flow is calculated using a similarity law for the air on the pavement and the wall and in the street canyon

Q_{E,r}=lᵥBᵣρC_{H1}U_{can}(qᵣ−q_{can})

Q_{E,w}=0

wherein C_{H2} is a dimensionless velocity transfer coefficient, and qᵣ is a humidity of the pavement; a q_{can} is a humidity at the street canyon,

A latent heat flow between an interior of the street canyon and a top atmosphere is

Q_{E,can}=lᵥρC_{H2}Uₐᵢᵣ(q_{can}−qₐᵢᵣ)

The net heat storage flux ΔQ_{S} includes:

Because there is a temperature gradient inside the building or the pavement, the roof, the wall and the pavement are assumed to be of at least three-layer structures. For an outermost layer structure, heat transfer equations of the three planes are written as,

$${C}_{R 1} \frac{\partial {T}_{R 1}}{\partial t} = \frac{{λ}_{R 1}}{{d}_{R 1}} ( {S}_{R}^{*} + {L}_{R}^{*} - {H}_{R} - {LE}_{R} - {G}_{R 1 - 2} ) \\ {C}_{w 1} \frac{\partial {T}_{w 1}}{\partial t} = \frac{{λ}_{w 1}}{{d}_{w 1}} ( {S}_{w}^{*} + {L}_{w}^{*} - {H}_{w} - {G}_{w 1 - 2} ) \\ {C}_{r 1} \frac{\partial {T}_{r 1}}{\partial t} = \frac{{λ}_{r 1}}{{d}_{r 1}} ( {S}_{r}^{*} + {L}_{r}^{*} - {H}_{r} - {LE}_{r} - {G}_{r 1 - 2} )$$

where T_{*i} is temperature of the i-th layer; C_{*i} is a specific heat capacity of the air; d_{*i} is a layer thickness, fluxes S_{*}*, L_{*}*, H_{*}, LE_{*}, and G_{*1-2} are net solar radiation, net infrared radiation, sensible heat, latent heat, and thermal conductivity between the surface layer and the lower layer, and the thermal conductivity is calculated using a Fourier heat conduction equation,

$${G}_{* 1 - 2} = \frac{{λ}_{* 1 - 2}}{0 \text{.5} ( {d}_{* 1} + {d}_{* 2} )} ( {T}_{* 1} - {T}_{* 2} )$$

An average thermal conductivity between two adjacent layers λ_{*1-2} is calculated using a geometric average method:

$${λ}_{* 1 - 2} = \frac{{d}_{* 1} + {d}_{* 2}}{( {d}_{* 1} / {λ}_{* 1} ) + ( {d}_{* 2} / {λ}_{* 2} )}$$

where λ_{*i} is a thermal conductivity of the i-th layer;

An inner first layer of the surface is assumed to be a very thin surface, and a temperature of the first layer is simplified to an outer surface temperature; for other inner i-th layers, a thermal conductivity between adjacent layers is calculated; for an innermost layer, such as the n-th layer, an internal temperature of the building issued for the roof and the wall surface, and the 0 flux is used for the pavement;

$${G}_{R n - n + 1} = \frac{{λ}_{R n}}{0.5 {d}_{R n}} ( {T}_{R n} - {T}_{i n} )$$

$${G}_{w n - n + 1} = \frac{{λ}_{w n}}{0.5 {d}_{w n}} ( {T}_{w n} - {T}_{i n} )$$

$${G}_{r n - n + 1} = 0$$

The internal temperature of the building Tᵢₙ and the temperature of the external street canyon are assumed in a quasi-steady equilibrium state, then, if it is assumed that the internal temperature Tᵢₙ of the building under air conditioning or natural ventilation is substantially constant in a tropical island climate, an average temperature in a center of the interior of the building Tᵢₙ is

$${T}_{i n} = \frac{{( h / b )}^{2} ( {T}_{w w} + {T}_{w w} ) + {T}_{R}}{2 {( h / b )}^{2} + 1}$$

where b is an average width of the building.

The advantage of simplifying the internal temperature of the building is that there is no need to assume a source term existing inside the building in the presence of a space heating or cooling system; moreover, the power consumption of the heating or cooling system inside the building is difficult to estimate. In this way, the heat flux storage inside the building can be uniformly treated with temperature boundary conditions.

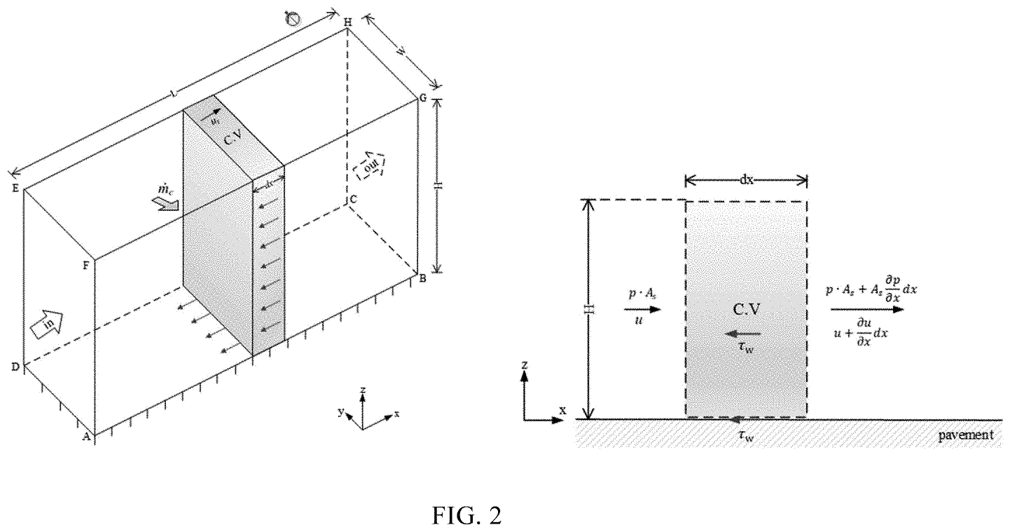

The wind velocity includes: as shown in FIG. 2, in the street canyon, the wind velocity is decomposed into a vertical velocity W_{can} along the wall and a horizontal velocity U_{can} along the length of the street; the horizontal velocity along the width of the street is ignored;

According to an observation, in a part close to the top of the street canyon, regardless of an air stability and a wind direction above the street canyon, a standard deviation σ_{w} of a vertical wind velocity is equal to a friction velocity u_{*};

The part σ_{w}/u_{*} close to the roof is 1.15, which is the same order of magnitude as an observed result. For an inertial boundary layer, a deviation of u_{*} is not more than 10%. Therefore, for any aspect ratio of the street canyon, the vertical velocity is assumed to be

W_{can}=u_{*}=\sqrt{C_{d}}┌Uₐᵢᵣ┐

where Uₐᵢᵣ is a wind velocity of the first layer of an atmospheric model, and C_{d} is a drag coefficient, which is calculated from the temperature/humidity in and above the street canyon, a roughness Z₀, and a stability effect;

The horizontal wind velocity at the top of the street canyon U_{can} is obtained by means of a Log approximate curve, a processing range of the Log curve is from h/3 of a lower part of the roof to a height of the first layer of the atmospheric model, wherein h is the height of the street canyon. When all street canyon orientations are considered, 360° integral processing is performed, then the velocity at the top of the street canyon Uₜₒₚ is

$${U}_{top} = \frac{2}{π} \frac{ln ( \frac{h / 3}{{z}_{0}} )}{ln ( \frac{Δ z + h / 3}{{z}_{0}} )} ⌈ {U}_{a i r} ⌉$$

where Δz is a height from the roof to the first layer of the atmospheric model;

The horizontal wind velocity U_{can} is determined according to the wind velocity at ½ height of the street canyon;

In order to calculate U_{can}, a reasonable change law of U_{can} in the vertical direction needs to be assumed;

According to a continuity assumption of the wind velocity, a change curve of U_{can} in the vertical direction has the following form

U_{can}=Uₜₒₚ exp(−N/2)

where a value of N is slightly different;

According to an aspect ratio of the street canyon (h/w=1-4), the value of U_{can} varies from 0.75 Uₜₒₚ to 0.4 Uₜₒₚ;

N=0.5(h/w), the horizontal wind velocity in the street canyon U_{can} is

$${U}_{c a n} = \frac{2}{π} exp ( - 0.25 \frac{h}{w} ) \frac{ln ( \frac{h / 3}{{z}_{0}} )}{ln ( \frac{Δ z + h / 3}{{z}_{0}} )} ⌈ {U}_{a i r} ⌉$$

Calculations of aerodynamic roughness of the pavement and the wall in the street canyon are simplified, and the two are considered to have equal aerodynamic roughness, which is unrelated to the stability inside and outside the street canyon,

RES_{w}=RESᵣ=(11.8+4.2\sqrt{U_{can}²+W_{can}²})⁻¹

where the parameters RES_{w} and RESᵣ are inverses of CₚC_{H1} and CₚC_{H2}, and are used for calculating sensible and latent heat flows.

The net convective heat flux is:

Under quasi-steady state conditions, the wind flow in an x-axis direction has been stable along the length of the street canyon; if an influence of pedestrians and vehicles inside the street is not considered, laws of mass conservation and momentum conservation are used in the x-axis direction, so as to obtain the horizontal movement of air inside the street canyon;

If the air density and the horizontal velocity in the street canyon are processed as quasi-steady state variables, then in the case where an entrance velocity and an exit velocity satisfy outflow conditions, the laws of mass conservation and momentum conservation are written as follows according to a one-dimensional flow equation in the x-axis direction:

$$\{ \begin{matrix}\frac{\partial ( ρ \overline{u} )}{\partial x} = {\dot{m}}_{c} \\ \frac{\partial ( ρ {\overline{u}}^{2} )}{\partial x} + \frac{\partial p}{\partial x} + \frac{\partial {τ}_{w}}{\partial x} = 0 \\ {\overline{u} \vert}_{x = {x}_{0}} = {\overline{u}}_{i n} \\ {\overline{u} \vert}_{x = {x}_{0} + L} = {\overline{u}}_{out} \\ {\frac{d \overline{u}}{dx} \vert}_{x = {x}_{0} + L}\end{matrix}$$

where ρ is the air density; ū is an average velocity in the x-axis direction; \dot{m}_{c} is a specific volumetric mass flow of air entering or exiting a control body, a specific volume being a ratio of the mass flow of the air entering or exiting the control body to the volume of the control body; p is an average pressure of a cross section of the street canyon; τ_{w} is an average frictional stress of the wall surface and the street surface to the air flow; ūᵢₙ and ūₒᵤₜ are average air velocities at the entrance and exit of the street canyon, respectively; x₀ is an entrance position of the street canyon, and the flow velocity at the entrance of the street canyon is measured by an instrument;

From a perspective of regional scale, streets are usually connected to form a street network; by studying a road network, a horizontal flux of the urban heat island phenomenon can be replaced by a street canyon formed by only one independent street; when the horizontal flux of a crossroad is calculated, a Kirchhoff's principle for calculating a fluid network can be used; according to a topological structure and plan theory of the street network, a street network can be represented by a corresponding adjacency matrix, and the horizontal air flow of each branch can be solved.

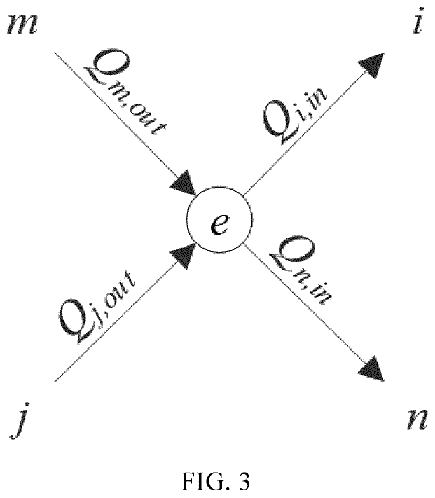

As shown in FIG. 3, for a scenario at a crossroad, it is assumed that the horizontal flux at the exit of street m is Q_{m,out} and the horizontal flux at the exit of street/is Q_{j,out}, the horizontal flux at the entrance of street i is Q_{i,out} and the horizontal flux at the entrance of street n is Q_{n,out}; then, according to aa law of energy conservation, a horizontal flux at a node is:

(ρ\dot{V}ₘQ_{m,out})+(ρ\dot{V}ⱼQ_{j,out})=ρQₘᵢₙ(\dot{V}ₙ+\dot{V}ᵢ)

where \dot{V} is an air volume flow of each street canyon; Qₘᵢₓ is a mixed horizontal flux;

The mixed horizontal flux Qₘᵢₓ is the horizontal flux flowing into the entrances of street canyons n and i at the node,

$${Q}_{m i x} = \frac{ρ {\sum }_{All outflowing branch} {( \dot{V} )}^{k}}{{\sum }_{All inflowing branch} {( ρ \dot{V} {Q}_{o u t} )}^{k}} .$$

Beneficial Effects:

With the continuous rapid development of cities, the urban heat island effect is increasingly serious. The remission of urban heat islands can help suppress the spread of infectious diseases, reduce greenhouse gas emissions, and reduce building energy consumption. In order to study the heat island effect, the urban canopy model is required to model a region. The improvement on the adaptability of the model is the basis for improving the accuracy of the model for the study on the heat island effect.

The new tropical island urban canopy model proposed here considers the influence of horizontal convective flux on the heat island effect, which makes up for the deficiency of the classical urban canopy model in the study on the heat island effect of “tropical island” cities, and has higher adaptability to the “tropical island” cities. In addition, the new model, i.e. an urban canopy model of a three-dimensional space, is built based on the finite length of a street canopy. This improvement can greatly improve the calculation accuracy of the horizontal heat flux in the street canyon.

The above specific embodiments further describe the objectives, technical solutions and beneficial effects of the present invention in detail. It should be understood that the above are only specific embodiments of the present invention, and are not intended to limit the protection scope of the present invention. Any modifications, equivalent replacements, improvements, etc. made within the spirit and principle of the present invention should be included within the protection scope of the present invention.

What is claimed is:

1. A method for building an urban canopy model based on tropical island climate characteristics, wherein the method comprises:
linking adjacent regions together, multiple streets of finite lengths within the regions affecting each other;
wherein an energy balance equation in a street is as follows:
Q*ₛ+Q_{F,s}=Q_{H,s}+Q_{E,s}+ΔQ_{S,s}+ΔQ_{A,s} Equation 1
wherein Q* is a net radiation heat flux, in unit of W/m²; Q_{F} is an anthropogenic heat production, in unit of W/m²; Q_{H} is a sensible heat flux, in unit of W/m²; Q_{E} is a latent heat flux, in unit of W/m²; ΔQ_{S} is a net heat storage flux, in unit of W/m²; ΔQ_{A} is a net convective heat flux, in unit of W/m²; s is the street;
wherein net radiation heat flux Q*=a long-wave radiation+a short-wave radiation.

2. The method according to claim 1, wherein the long-wave radiation comprises:
a net long-wave radiation of a pavement Lᵣ* is:
Lᵣ*=ϵᵣΨᵣL^{↓}−ϵᵣσTᵣ⁴+ϵᵣϵ_{w}(1−Ψᵣ)σT_{w}⁴+ϵᵣ(1−ϵ_{w})(1−Ψᵣ)Ψ_{w}L^{↓}+ϵᵣϵ_{w}(1−ϵ_{w})(1−‥ᵣ)(1−2Ψ_{w})σT_{w}⁴+ϵᵣ(1−ϵ_{w}(1−Ψᵣ)Ψ_{w}σϵᵣTᵣ⁴
and a net long-wave radiation of a wall L_{w}* is:
L_{w}*=ϵ_{w}Ψ_{w}L^{↓}−ϵ_{w}σT_{w}⁴+ϵ_{w}Ψ_{w}σϵᵣTᵣ⁴+ϵ_{w}²(1−2Ψ_{w})σT_{w}⁴+ϵ_{w}(1−ϵᵣ)ΨᵣΨ_{w}L^{↓}+ϵ_{w}(1−ϵ_{w})Ψ_{w}(1−2Ψ_{w})L^{↓}+ϵ_{w}²(1−ϵ_{w})(1−2Ψ_{w})²σT_{w}⁴+ϵ_{w}²(1−ϵᵣ)Ψ_{w}(1−Ψᵣ)σT_{w}⁴+ϵ_{w}(1−ϵ_{w})Ψ_{w}(1−2Ψ_{w})σϵᵣTᵣ⁴
where L↓ is an amount of solar radiation, σ is a standard deviation, Tᵣ and T_{w} are temperatures of the pavement and the wall, and ϵᵣ and ϵ_{w} are emissivities of the pavement and the wall; for the pavement, if Ψᵣ is a sky viewing angle coefficient of the pavement to the sky, amount of solar radiation, (1−Ψᵣ) is a sky viewing angle coefficient of the pavement to the walls on both sides; a sky viewing angle coefficient of the wall to the sky is Ψ_{w}, a sky viewing angle coefficient to the pavement is Ψ_{w}, then a sky viewing angle coefficient to the opposite wall is (1−2Ψ_{w}), and the sky viewing angle coefficient is 1.0 for a roof;
the sky viewing angle coefficient is calculated using a plane angle, the sky viewing angle coefficient at a w/2 position of the pavement is
$${Ψ}_{r} ( y = w / 2 ) = 1 + \frac{1}{π} {tan}^{- 1} ( \frac{h / w}{{( h / w )}^{2} - 1 / 4} ) for h / w \leq 1 / 2$$
$${Ψ}_{r} ( y = w / 2 ) = 1 - \frac{1}{π} {tan}^{- 1} ( \frac{h / w}{{( h / w )}^{2} - 1 / 4} ) for h / w \geq 1 / 2$$
the sky viewing angle coefficient at an intersection of the wall and the pavement is
$${Ψ}_{w} ( z = 0 ) = \frac{1}{π} {tan}^{- 1} ( \frac{1}{h / w} ) ,$$
where h represents a height of a street canyon, and w represents a width of the street canyon.

3. The method according to claim 1, wherein the short-wave radiation comprises:
average direct solar radiant fluxes of the pavement [symbol] , a west wall [symbol] , an east wall [symbol] and the roof [symbol] are calculated according to a perpendicular angle of the street to a sun direction:
$${S}_{r}^{⇓} ( θ = \frac{π}{2} ) = \{ \begin{matrix}0 & for \vert λ \vert > {λ}_{0} \\ [ 1 - \frac{h}{w} tan ( λ ) ] {S}^{⇓} & for \vert λ \vert < {λ}_{0}\end{matrix}$$
$${S}_{w w}^{⇓} ( θ = \frac{π}{2} ) = \{ \begin{matrix}\frac{1}{2} \frac{w}{h} {S}^{⇓} & for - \frac{π}{2} \leq λ \leq - {λ}_{0} \\ \frac{1}{2} tan ( λ ) {S}^{⇓} & for - {λ}_{0} \leq λ \leq 0 \\ 0 & for 0 \leq λ \leq \frac{π}{2}\end{matrix}$$
$${S}_{w e}^{⇓} ( θ = \frac{π}{2} ) = \{ \begin{matrix}0 & for - \frac{π}{2} \leq λ \leq - {λ}_{0} \\ \frac{1}{2} tan ( λ ) {S}^{⇓} & for - {λ}_{0} \leq λ \leq 0 \\ \frac{1}{2} \frac{w}{h} {S}^{⇓} & for 0 \leq λ \leq \frac{π}{2}\end{matrix}$$
$${S}_{R}^{⇓} ( θ = \frac{π}{2} ) = χ {S}^{⇓}$$
where [symbol] is direct solar radiation on a horizontal surface, θ is an angle between a sun angle and an axial direction of the canyon, λ is an angle between a sun direction and a normal direction of the wall, χ is a ratio of a direct radiation to a total radiation at a top of the street canyon, h is a height of the street canyon, and w is a width of the street canyon;
according to an orientation change of the street canyon, the width w of the street canyon is corrected as w/sin θ; after a heat flux of the wall is obtained, the heat flux of the wall is multiplied by sin θ for correction, where θ₀ is an orientation of the street canyon where the pavement does not receive direct sunlight at all
$${θ}_{0} = arcsin ( min ( \frac{w}{h} \frac{1}{tan λ} ; 1 ) )$$
all direct radiant fluxes obtained by the street canyon are averaged according to all possible changes in the direction of the street canyon, wherein two integrals are used, one between θ=0 and θ=θ₀, and the other between θ=θ₀ and
$$θ = \frac{π}{2} ;$$
wherein average direct solar fluxes of the wall, the pavement and the roof are:
$${S}_{r}^{⇓} = {S}^{⇓} [ \frac{2 {θ}_{0}}{π} - \frac{2}{π} \frac{h}{w} tan ( λ ) ( 1 - cos ( {θ}_{0} ) ) ]$$
$${S}_{w}^{⇓} = {S}^{⇓} [ \frac{w}{h} ( \frac{1}{2} - \frac{{θ}_{0}}{π} ) + \frac{1}{π} tan ( λ ) ( 1 - cos ( {θ}_{0} ) ) ]$$
$${S}_{R}^{⇓} = {S}^{⇓}$$
S^{↓} is a scattered solar radiation available on the horizontal surface, and an amount of scattered solar radiation received by a surface in the street canyon is directly obtained from the sky viewing angle coefficient; due to an influence of a shape of the street canyon and high-reflectivity building surface materials, the short-wave radiation is calculated to solve a geometric system with an infinite number of reflecting surfaces, a reflecting processes of which are assumed to be isentropic processes;
when direct and diffuse reflectivities of each surface are the same, an energy stored by the pavement Aᵣ and an energy stored by the wall A_{w} when a first reflection occurs are:
Aᵣ(0)=(1−αᵣ)( [symbol] +Sᵣ^{↓})
A_{w}(0)=(1−α_{w})( [symbol] +S_{w}^{↓})
where αᵣ and α_{w} represent the reflectivities of the pavement and the wall, respectively;
the energies of the reflected parts from the pavement Rᵣ and from the wall R_{w} are:
Rᵣ(0)=αᵣ( [symbol] +Sᵣ^{↓})
R_{w}(0)=α_{w}( [symbol] +S_{w}^{↓})
after n reflections occur,
Aᵣ(n+1)=Aᵣ(n)+(1−αᵣ)(1−Ψᵣ)R_{w}(n)
A_{w}(n+1)=A_{w}(n)+(1−αᵣ)‥_{w}Rᵣ(n)+(1−α_{w})(1−2Ψ_{w})R_{w}(n)
Rᵣ(n+1)=αᵣ(1−Ψᵣ)R_{w}(n)
R_{w}(n+1)=α_{w}‥_{w}Rᵣ(n)+α_{w}(1−2Ψ_{w})R_{w}(n)
the following is obtained according to recursive formulas,
$${A}_{r} ( n + 1 ) = {A}_{r} ( 0 ) + ( 1 - {α}_{r} ) ( 1 - {Ψ}_{r} ) {\sum }_{k = 0}^{n} {R}_{w} ( k )$$
$${A}_{w} ( n + 1 ) = {A}_{w} ( 0 ) + {Ψ}_{w} ( 1 - {α}_{r} ) {\sum }_{k = 0}^{n} {R}_{w} ( k ) + ( 1 - 2 {Ψ}_{w} ) ( 1 - {α}_{w} ) {\sum }_{k = 0}^{n} {R}_{w} ( k )$$
$$and$$
$${\sum }_{k = 0}^{n} {R}_{r} ( k ) = ( 1 - {Ψ}_{r} ) {α}_{r} {\sum }_{k = 0}^{n - 1} {R}_{w} ( k ) + {R}_{r} ( 0 )$$
$${\sum }_{k = 0}^{n} {R}_{w} ( k ) = {α}_{w} {Ψ}_{w} {\sum }_{k = 0}^{n - 1} {R}_{r} ( k ) + {α}_{w} ( 1 - 2 {Ψ}_{w} ) {\sum }_{k = 0}^{n - 1} {R}_{w} ( k ) + {R}_{w} ( 0 )$$
for the infinite reflections, the following is obtained by solving a geometric system,
$${\sum }_{k = 0}^{∞} {R}_{r} ( k ) = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}} \\ {\sum }_{k = 0}^{∞} {R}_{r} ( k ) = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}}$$
Mᵣ is assumed to be a sum of a pavement reflection and M_{w} is assumed to be a sum of a wall reflection,
$${M}_{r} = \frac{{R}_{r} ( 0 ) + ( 1 - {Ψ}_{r} ) {α}_{r} ( {R}_{w} ( 0 ) + {Ψ}_{w} {α}_{w} {R}_{r} ( 0 ) )}{1 - ( 1 - 2 {Ψ}_{w} ) {α}_{w} + ( 1 - {Ψ}_{r} ) {Ψ}_{w} {α}_{r} {α}_{w}} \\ {M}_{w} = \frac{{R}_{w} ( 0 ) + {Ψ}_{w} {α}_{w} {R}_{r} ( 0 )}{1 ( 1 - 2 {Ψ}_{w} ) {α}_{w} + ( 1 - {Ψ}_{r} ) {Ψ}_{w} {α}_{r} {α}_{w}}$$
where
Rᵣ(0)=αᵣ [symbol] +αᵣSᵣ^{↓}
R^{w}(0)=αᵣ [symbol] +αᵣS_{w}^{↓}
a total solar radiation absorbed by the pavement is Sᵣ*, a total solar radiation absorbed by the wall is S_{w}^{*}, a total solar radiation absorbed by the roof is S_{R}*:
Sᵣ*=(1−αᵣ) [symbol] +(1−αᵣ)Sᵣ^{↓}+(1−αᵣ)(1−Ψᵣ)M_{w}
S_{w}*=(1−α_{w}) [symbol] +(1−α_{w})S_{w}^{↓}+(1−α_{w})(1−2Ψ_{w})M_{w}+(1−α_{w})Ψ_{w}Mᵣ
S_{R}*=(1−α_{R}) [symbol] +(1−α_{R})S_{R}^{↓}.

4. The method according to claim 1, wherein the anthropogenic heat production specifically comprises:
a current anthropogenic heat flux in the street canyon is Q_{F}=Q_{FV}+Q_{FH}+Q_{FM};
where Q_{FV}, Q_{FH} and Q_{FM} are heat generated by vehicles, fixed heat sources and biological metabolism, respectively.

5. The method according to claim 1, wherein the sensible heat flux Q_{H} comprises:
Q_{H,r,ww,we}=ρCₚC_{H1}U_{can}(T_{r,ww,we}−T_{can})
Q_{H,R}=ρCₚC_{H2}Uₜₒₚ(T_{R}−Tₐᵢᵣ)
Q_{H,can}=ρCₚC_{H2}Uₐᵢᵣ(T_{can}−Tₐᵢᵣ)
where r, ww, we, R, and can refer to the pavement, the west wall, the east wall, the roof, and the street canyon, respectively; ρ is an air density; Cₚ is a specific heat under a constant pressure; T_{can} is a temperature in a center of the street canyon (w/2, h/2); U_{can} and Uₜₒₚ are a wind velocity in the center of the street canyon (w/2, h/2) and a wind velocity above the street canyon;
Uₐᵢᵣ and Tₐᵢᵣ are an input wind velocity and an input temperature at a reference height of a turbulence model, and C_{H1} and C_{H2} are dimensionless velocity transfer coefficients; differences between the C_{H1} and C_{H2} are only a height and a roughness of a reference layer; the same zero plane layer and roughness are used, and the values of the two are equal, and are calculated as follows:
$${C}_{H *} {u}_{*} = \frac{{ku}_{*}}{{Ψ}_{h}}$$
where k is a Von Karman constant, u_{*} is a friction velocity of the reference layer, and Ψₕ is a general integral function,
$${Ψ}_{h} = {\int }_{{ζ}^{T}}^{{ζ}^{′}} \frac{{ϕ}_{h}}{ζ} d ζ$$
where ζ′=(zₐ−d)/L; ζ^{T}=z_{T}/L, z_{T} is a roughness length of a heat flow; L is an Obukhov stability length,
$$L = - \frac{ρ {C}_{p} {Tu}_{*}^{3}}{{kgH}_{a}}$$
where T is an average temperature of this layer, Hₐ is an air flux between the street canyon and an atmosphere, and L is an implicit function, which is solved by simplified iteration; when a specific heat of air in an urban canopy is ignored, Hₐ is a weighted average of a wall flux and a road flux in the street canyon, that is,
Hₐ=2(h/w)Q_{w}+Q_{R}
in a TEB model proposed by Masson, C_{H*}u_{*} is a reciprocal of aerodynamic resistance, i.e. 1/RES_{*}, which is determined by the wind velocities in the street canyon and at a top of the street canyon;
if a surface covered by plants such as green space is not considered, an average sensible heat flow of the street canyon depends on a weighted average area of the roof, the wall and the pavement,
$${Q}_{H} = \frac{{bQ}_{H , R} + {wQ}_{H , r} + h ( {Q}_{H , ww} + {Q}_{H , we} )}{w + b} ,$$
wherein h is a height of the street canyon, w is a width of the street canyon, and b is an average width of the buildings.

6. The method according to claim 1, wherein the latent heat flux Q_{E} comprises:
a direct latent heat flow between a building roof and the atmosphere
Q_{E,R}=lᵥB_{R}ρC_{H2}Uₜₒₚ(q_{R}−qₐᵢᵣ)
where lᵥ is a latent heat of evaporation, B_{R} is a humidity parameter of the roof, between 0 and 1, 0 is completely dry, 1 is completely wet, a value of B depends on the plant and a water conditions of the surface, ρ is a density of the air, C_{H2} is a dimensionless velocity transfer coefficient, and q_{R} is a humidity of the roof; qₐᵢᵣ is a humidity at the reference height,
a latent heat flow is calculated using a similarity law for the air on the pavement and the wall and in the street canyon
Q_{E,r}=lᵥBᵣρC_{H1}U_{can}(qᵣ−q_{can})
Q_{E,w}=0
wherein C_{H2} is a dimensionless velocity transfer coefficient, and qᵣ is a humidity of the pavement; q_{can} is a humidity at the street canyon,
a latent heat flow between an interior of the street canyon and a top atmosphere is
Q_{E,can}=lᵥρC_{H2}Uₐᵢᵣ(q_{can}−qₐᵢᵣ).

7. The method according to claim 1, wherein the net heat storage flux ΔQ_{S} comprises:
because there is a temperature gradient inside the building or the pavement, the roof, the wall and the pavement are assumed to be of at least three-layer structures; for an outermost layer structure, heat transfer equations of the three planes are written as,
$${C}_{R 1} \frac{\partial {T}_{R 1}}{\partial t} = \frac{{λ}_{R 1}}{{d}_{R 1}} ( {S}_{R}^{*} + {L}_{R}^{*} - {H}_{R} - {LE}_{R} - {G}_{R 1 - 2} ) \\ {C}_{w 1} \frac{\partial {T}_{w 1}}{\partial t} = \frac{{λ}_{w 1}}{{d}_{w 1}} ( {S}_{w}^{*} + {L}_{w}^{*} - {H}_{w} - {G}_{w 1 - 2} ) \\ {C}_{r 1} \frac{\partial {T}_{r 1}}{\partial t} = \frac{{λ}_{r 1}}{{d}_{r 1}} ( {S}_{r}^{*} + {L}_{r}^{*} - {H}_{r} - {LE}_{r} - {G}_{r 1 - 2} )$$
where T_{*i} is a temperature of the i-th layer; C_{*i} is a specific heat capacity of the air; d_{*i} is a layer thickness, fluxes S_{*}*, L_{*}*, LE_{*}, and G_{*1-2} are net solar radiation, net infrared radiation, sensible heat, latent heat, and thermal conductivity between the surface layer and the next layer, and the thermal conductivity is calculated using a Fourier heat conduction equation,
$${G}_{* 1 - 2} = \frac{{λ}_{* 1 - 2}}{0.5 ( {d}_{* 1} + {d}_{* 2} )} ( {T}_{* 1} - {T}_{* 2} )$$
an average thermal conductivity between two adjacent layers λ_{*1-2} is calculated using a geometric average method:
$${λ}_{* 1 - 2} = \frac{{d}_{* 1} + {d}_{* 2}}{( {d}_{* 1} / {λ}_{* 1} ) + ( {d}_{* 2} / {λ}_{* 2} )}$$
where λ_{*i} is a thermal conductivity of the i-th layer;
an inner first layer of the surface is assumed to be a very thin surface, and a temperature of the first layer is simplified to an outer surface temperature; for other inner i-th layers, a thermal conductivity between adjacent layers is calculated; for an innermost layer, such as the n-th layer, an internal temperature of the building is used for the roof and the wall surface, and the 0 flux is used for the pavement;
$${G}_{Rn - n + 1} = \frac{{λ}_{Rn}}{0.5 {d}_{Rn}} ( {T}_{Rn} - {T}_{i n} ) \\ {G}_{wn - n + 1} = \frac{{λ}_{wn}}{0.5 {d}_{wn}} ( {T}_{wn} - {T}_{i n} ) \\ {G}_{rn - n + 1} = 0$$
the internal temperature of the building Tᵢₙ and the temperature of the external street canyon are assumed in a quasi-steady equilibrium state, then, if it is assumed that the internal temperature Tᵢₙ of the building under air conditioning or natural ventilation is substantially constant in a tropical island climate, an average temperature in a center of the interior of the building Tᵢₙ is
$${T}_{i n} = \frac{{( h / b )}^{2} ( {T}_{ww} + {T}_{ww} ) + {T}_{R}}{2 {( h / b )}^{2} + 1}$$
where b is an average width of the building.

8. The method according to claim 1, wherein the wind velocity comprises:
in the street canyon, the wind velocity is decomposed into a vertical velocity W_{can} along the wall and a horizontal velocity U_{can} along the length of the street; the horizontal velocity along the width of the street is ignored;
according to an observation, in a part close to the top of the street canyon, regardless of an air stability and a wind direction above the street canyon, a standard deviation σ_{w} of a vertical wind velocity is equal to a friction velocity u_{*};
the part σ_{w}/u_{*} close to the roof is 1.15, which is the same order of magnitude as an observed result; for an inertial boundary layer, a deviation of u_{*} is not more than 10%; therefore, for any aspect ratio of the street canyon, the vertical velocity is assumed to be
W_{can}=u_{*}=\sqrt{C_{d}}┌Uₐᵢᵣ┐
where Uₐᵢᵣ is a wind velocity of the first layer of an atmospheric model, and C_{d} is a drag coefficient, which is calculated from the temperature/humidity in and above the street canyon, a roughness Z₀, and a stability effect;
the horizontal wind velocity at the top of the street canyon U_{can} is obtained by means of a Log approximate curve, a processing range of the Log curve being from h/3 of a lower part of the roof to a height of the first layer of the atmospheric model, wherein h is the height of the street canyon; when all street canyon orientations are considered, 360° integral processing is performed, then the velocity at the top of the street canyon Uₜₒₚ is
$${U}_{top} = \frac{2}{π} \frac{ln ( \frac{h / 3}{{z}_{0}} )}{ln ( \frac{Δ z + h / 3}{{z}_{0}} )} ⌈ {U}_{air} ⌉$$
where Δz is a height from the roof to the first layer of the atmospheric model;
the horizontal wind velocity U_{can} is determined according to the wind velocity at ½ height of the street canyon;
in order to calculate U_{can}, a reasonable change law of U_{can} in the vertical direction needs to be assumed;
according to a continuity assumption of the wind velocity, a change curve of U_{can} in the vertical direction has the following form
U_{can}=Uₜₒₚ exp(−N/2)
where a value of N is slightly different;
according to an aspect ratio of the street canyon (h/w=1-4), the value of U_{can} varies from 0.75 Uₜₒₚ to 0.4 Uₜₒₚ;
N=0.5(h/w), the horizontal wind velocity in the street canyon U_{can} is
$${U}_{can} = \frac{2}{π} exp ( - 0.25 \frac{h}{w} ) \frac{ln ( \frac{h / 3}{{z}_{0}} )}{ln ( \frac{Δ z + h / 3}{{z}_{0}} )} ⌈ {U}_{air} ⌉$$
calculations of aerodynamic roughness of the pavement and the wall in the street canyon are simplified, and the two are considered to have equal aerodynamic roughness, which is unrelated to the stability inside and outside the street canyon,
RES_{w}=RESᵣ=(11.8+4.2\sqrt{U_{can}²+W_{can}²})⁻¹
where the parameters RES_{w} and RESᵣ are inverses of CₚC_{H1} and CₚC_{H2}, and are used for calculating sensible and latent heat flows.

9. The method according to claim 1, wherein the net convective heat flux is:
under quasi-steady state conditions, the wind flow in an x-axis direction has been stable along the length of the street canyon; if an influence of pedestrians and vehicles inside the street is not considered, laws of mass conservation and momentum conservation are used in the x-axis direction, so as to obtain the horizontal movement of air inside the street canyon;
if the air density and the horizontal velocity in the street canyon are processed as quasi-steady state variables, then in the case where an entrance velocity and an exit velocity satisfy outflow conditions, the laws of mass conservation and momentum conservation are written as follows according to a one-dimensional flow equation in the x-axis direction:
$$\{ \begin{matrix}\frac{\partial ( p \overline{u} )}{\partial x} = {\dot{m}}_{c} \\ \frac{\partial ( p {\overline{u}}^{2} )}{\partial x} + \frac{\partial p}{\partial x} + \frac{\partial {τ}_{w}}{\partial x} = 0 \\ \overline{u} {\vert}_{x = {x}_{0}} = {\overline{u}}_{i n} \\ \overline{u} {\vert}_{x = {x}_{0} + L} = {\overline{u}}_{out} \\ \frac{d \overline{u}}{dx} {\vert}_{x = {x}_{0} + L} = 0\end{matrix}$$
where ρ is the air density; ū is an average velocity in the x-axis direction; \dot{m}_{c} is a specific volumetric mass flow of air entering or exiting a control body, a specific volume being a ratio of the mass flow of the air entering or exiting the control body to the volume of the control body; p is an average pressure of a cross section of the street canyon; τ_{w} is an average frictional stress of the wall surface and the street surface to the air flow; ūᵢₙ and ūₒᵤₜ are average air velocities at the entrance and exit of the street canyon, respectively; x₀ is an entrance position of the street canyon, and the flow velocity at the entrance of the street canyon is measured by an instrument;
from a perspective of regional scale, streets are usually connected to form a street network; by studying a road network, a horizontal flux of the urban heat island phenomenon can be replaced by a street canyon formed by only one independent street; when the horizontal flux of a crossroad is calculated, a Kirchhoff's principle for calculating a fluid network can be used; according to a topological structure and plan theory of the street network, a street network can be represented by a corresponding adjacency matrix, and the horizontal air flow of each branch can be solved;
for a scenario at a crossroad, it is assumed that the horizontal flux at the exit of street m is Q_{m,out} and the horizontal flux at the exit of street j is Q_{j,out}, the horizontal flux at the entrance of street i is Q_{i,out} and the horizontal flux at the entrance of street n is Q_{n,out}; then, according to a law of energy conservation, a horizontal flux at a node is:
(ρ\dot{V}ₘQ_{m,out})+(ρ\dot{V}ⱼQ_{j,out})=ρQₘᵢₙ(\dot{V}ₙ+\dot{V}ᵢ)
where \dot{V} is an air volume flow of each street canyon; Qₘᵢₓ is a mixed horizontal flux;
the mixed horizontal flux Qₘᵢₓ is the horizontal flux flowing into the entrances of street canyons n and i at the node,
$${Q}_{mix} = \frac{ρ {\sum }_{All outflowing branch} {( \dot{V} )}^{k}}{{\sum }_{All inflowing branch} {( ρ \dot{V} {Q}_{out} )}^{k}} .$$
